(19) United States
(12) Patent Application Publication
(10) Pub. No.: US 2026/0001729 A1
(43) Pub. Date: Jan. 1, 2026

(54) INTERLEAVANT PARTICLES FOR LOCATION BETWEEN GLASS SHEETS

(71) Applicant: Mitsubishi Chemical UK Limited, Billingham (GB)

(72) Inventors: Michael Stephen CHISHOLM, Durham (GB); Philip Andrew STENSON, Durham (GB)

(21) Appl. No.: 18/881,513

(22) PCT Filed: Jun. 29, 2023
(86) PCT No.: PCT/GB2023/051703

§ 371 Date: Jan. 6, 2025

(30) Foreign Application Priority Data
Jul. 7, 2022 (GB) 2210010.1

(51) Int. Cl. B65G 49/06; B65B 23/20; B65B 33/00; B65B 35/50; C08J 3/12

(52) U.S. Cl. CPC B65G 49/069; B65B 23/20; B65B 33/00; B65B 35/50; C08J 3/126; C08J 2301/02; C08J 2333/12; C08J 2493/04

(57) ABSTRACT

Interleavant particles for location between adjacent stacked glass sheets that include an organic polymer core with an outer coating comprising rosin. The organic polymer core has a softening point greater than 60° C., a solubility in water of less than 2 g/L, a compressive strength of at least 3 MPa and a volumetric mass density less than 1.6 g/cm³. A composition, methods of producing the particles and stacking glass sheets, use of the particles to space the glass sheets and a stack of glass sheets. In one method, a solid organic polymer core and a solid outer coating material are combined by high shear mixing wherein the outer coating material has a lower melting point than the core material and the high shear mixing is effective to melt the outer coating material and to effect coating thereof onto the solid organic polymer core.

### TECHNICAL FIELD

The present invention relates to interleavant particles for location between adjacent stacked usually glass sheets especially during manufacture, storage, and transport, and to interleavant compositions comprising such particles.

### BACKGROUND

Glass interleavants provide spacing between stacked glass sheets and thereby help to prevent abrasive contact, capillary adhesion, and corrosion by alkalis between adjacent glass sheets. Commonly used glass interleavants generally comprise non-biodegradable microplastics, such as LDPE (Low Density Polyethylene) and PMMA (Poly (methyl methacrylate)). In particular, the use of PMMA has a number of benefits over other types of glass interleavants, such as affordability, adhesion of interleavant powder to glass, and ease of removal with water. A key characteristic of PMMA interleavants is the acceptance of electrostatic charge which provides the advantageous adhesion. In addition, PMMA may be produced by suspension polymerisation where the final polymer particle is already of the suitable size for direct use as a glass interleavant. However, non-biodegradable microplastics are known to accumulate in the environment and may harm aquatic organisms and animals.

In January 2019, the European Commission proposed wide-ranging restrictions on the international use of microplastics in products placed on the EU/EEA market to avoid or reduce their release into the environment. The proposal aims at reducing the amount of microplastics emitted into the environment by at least 70% and thereby prevent the release of 500,000 tonnes of microplastics over the twenty-year period following its introduction.

Natural biodegradable materials such as paper, wood flour, natural fabrics, coconut husk flour, and starch have also been used as glass interleavants. These natural materials do not match the performance associated with non-biodegradable glass interleavants. In particular, these natural materials are less effective, particularly when wet, which may be problematic in humid or wet environments. Further disadvantages of natural biodegradable glass interleavants may include staining of the glass sheets, abrasive activity on the glass sheets, compressibility, hydrophilicity (which may lead to capillary uptake of water and subsequent undesirable sticking together of glass sheets) and an inability of interleavant powder to remain adhered to the glass sheets.

Accordingly, there is a need to provide alternative glass interleavants that are: better adhered, biodegradable or partially biodegradable, environmentally sustainable, match or substantially match the performance and ease of production of current glass interleavants or otherwise improve the properties of glass interleavants.

Glass interleavant compositions need to sufficiently adhere to the glass so that they remain in situ to act as interleavants whilst at the same time being easily removable when the glass sheets are to be used and without leaving any stain on the glass. Surprisingly, it has now been found that use of interleavant particles with an organic polymer core and an outer coating comprising rosin are able to increase the adherence of interleavant particles, especially those with larger mean particle sizes above 75 μm.

### SUMMARY OF INVENTION

According to a first aspect of the present invention there is provided interleavant particles for location between adjacent stacked glass sheets as claimed.

According to a second aspect of the present invention there is provided a method of providing a stack of spaced glass sheets as claimed.

According to a third aspect of the present invention there is provided the use of interleavant particles as claimed.

According to a fourth aspect of the present invention there is provided a stack of glass sheets as claimed.

According to a fifth aspect of the present invention there is provided interleavant compositions as claimed.

According to a sixth aspect of the present invention there is provided a method of producing the interleavant particles.

### DETAILED DESCRIPTION OF THE INVENTION

Advantageously, with the present invention it has been found that interleavant particles comprising an organic polymer core and an outer coating comprising rosin exhibit improved adhesion to glass sheets especially for interleavant particles with mean particle size >75 μm.

Furthermore, if the organic polymer core material comprises a biodegradable material, the interleavant particle may be fully or partially biodegradable and thereby release little or no microplastics into the natural environment.

The outer coating is typically in the form of a film. Accordingly, the outer coating forms into a film coating once applied to the core. The outer coating film forming material is generally the rosin due to its film forming properties. The outer coating also does not abrade the glass sheets and is usually able to accumulate sufficient electrostatic charge such that good adhesion to glass sheets is exhibited.

Alternatively, the material of the outer coating may itself be sufficiently tacky i.e. so as to adhere to glass in normal use of the interleavants. The film may also be formed from a powder coating.

In the present invention, the outer coating is typically in contact with the organic polymer core i.e. without an intermediate layer. The outer coating is typically not grafted or otherwise chemically bonded to the core by covalent or ionic bonds.

The term biodegradable herein may be taken as referring to material susceptible to degradation by biological activity. Herein biodegradable may be defined as >90% degradation within 24 months relative to a microcrystalline cellulose powder control sample. Degradation is measured as per methodology outlined in ISO 17556:2019 wherein it is quantified as carbon dioxide evolution from a sample of test material in a natural soil environment (using an inoculum that has not been pre-adapted) expressed as % carbon dioxide evolution relative to the theoretical maximum carbon dioxide evolution.

The biodegradable material for the core may also be environmentally sustainable. The term environmentally sustainable used throughout the description is taken to mean the use of natural resources in such a way that does not lead to long term damage of the environment including the biosphere.

Optionally, the biodegradable material for the core is hydrophobic. This helps to prevent or mitigate water retention on the surface of the glass sheets when in use, which may lead to staining of the glass during high temperatures or humid conditions. This may also prevent water from migrating to the core.

Typically, the outer coating adheres to the glass sheet surfaces under the influence of intrinsic tackiness and/or electrostatic charge when in use. Generally, where necessary, sufficient electrostatic charge is imparted by the applicators used for interleavants which charge the interleavant particles as they are sprayed on to the glass sheets. This helps to prevent the interleavant particles rolling or slipping off the glass sheet and becoming denuded in use.

The outer coating material may cover at least a part of the surface of the organic polymer core. Partially covering the surface of the organic polymer core with the outer coating material prevents or helps to mitigate abrasive contact between the core and the glass sheets. For example, the outer coating material helps to prevent the organic polymer core from scratching the glass sheets.

Typically, the outer coating material is contiguous with the organic polymer core so as to cover the entire surface of the core. Typically, the outer coating material envelopes the organic polymer core.

However, it is also possible to have less than 100% surface coating coverage of the organic polymer core and optionally for some of the core to also contact the glass sheets in use. The organic polymer core may have a surface coating coverage of >10% such as >20, 30, 40, 50 or 60% by the outer coating, typically >70%, more typically >80%, even more typically >90%. The organic polymer core may have a coating coverage of 100% by the outer coating.

The outer coating may be arranged to be in contact with the organic polymer core, typically, by direct coating of the core i.e. without an intervening layer and in relation to any of the above percentage coverages.

Although multiple coats of the outer coating may be applied to the organic polymer core, preferably only one coat of the outer coating is applied to the core.

Nevertheless, one or more additional coating layers may also be interposed between the outer coating and the organic polymer core. The one or more additional coating layers may independently cover at least a part of the surface of the organic polymer core.

The one or more additional coating layers may be otherwise defined as the outer coating herein.

Typically, the outer coating material leaves little or no residue on the glass surface.

The one or more additional coating layers may be biodegradable.

The interleavant particles may be environmentally sustainable. The outer coating may be environmentally sustainable. The biodegradable material used in the outer coating may be environmentally sustainable. The one or more additional coating layers may be environmentally sustainable. The outer coating material may also be biodegradable.

### The Particles

The interleavant particles or composition may have a mean particle size as determined by light scattering of <400 μm.

The interleavant particles or composition may have a mean particle size as determined by light scattering of >10 μm.

The interleavant particles or composition may have a mean particle size as determined by light scattering of from 20 to 300 μm.

The interleavant particles or composition may have a mean particle size as determined by light scattering of from 25 to 300 μm, typically from 30 to 250 μm, more typically from 40 to 200 μm, most typically from 50 to 170 μm, especially from 75 to 160 μm.

In terms of particle size distribution, the interleavant particles or composition may have <10% v/v total particles that are >400 μm, typically <1% v/v total particles that are >500 μm as determined by light scattering. The interleavant particles may have <10% v/v total particles that are <1 μm as determined by light scattering.

The mean particle size as determined by light scattering, as described previously, may provide uniform spacing between sheets of glass. This in-turn optimizes the amount of interleavant particles used and thereby reduces wastage.

Providing interleavant particles with a mean particle size as determined by light scattering may facilitate application of the interleavant particles to the surface of the glass.

The interleavant particles may be generally spherical or cylindrical in shape. Typically, the interleavant particles are generally spherical in shape. The interleavant particles may have a smooth or textured surface.

The interleavant particles herein may be broadly spherical. In any case, the particles will generally have an average aspect ratio of at least 0.5, such as at least 0.6, 0.7, 0.8, 0.9 or 0.95.

The core material is chosen to be capable of forming or being formed into generally spherical particles of the required size.

### The Core

The organic polymer core may comprise a polymer selected from:
a polyester such as a poly(lactic acid), a poly(butylene succinate), a poly(caprolactone) or a poly(hydroxyalkanoate) for example polyhydroxybutyrate,
a poly(ester-amide) such as a co-polymer of a poly(ester) and an amino acid or a co-polymer of a poly(ester) and an amino acid and an imide,
a polyurethane such as a polyurethane formed from a poly(ester) polyol and an aliphatic diisocyanate,
a poly(saccharide) or poly(saccharide) derivative such as chitin, keratin and chitosan, poly(ethylene glycol),
a poly(alkacrylate) or poly(acrylate) such as poly(alkyl alkacrylate), for example poly(alkyl methacrylate), especially poly(methyl methacrylate),
a poly(alkylene) such as a high-density poly(alkylene) for example a high density polyethylene, or such as a ultra-high-molecular-weight poly(alkylene), for example ultra-high-molecular-weight polyethylene,
a polystyrene,
natural biopolymers and derivatives such as cellulose as defined herein, suberin, melanin, lignin, cutin, cutan, starch and starch derivatives.

The organic polymer core may have a mean particle size as determined by light scattering of <400 μm.

The organic polymer core may have a mean particle size as determined by light scattering of >10 μm.

The organic polymer core may have a mean particle size as determined by light scattering of from 25 to 300 μm, typically from 30 to 250 μm, more typically from 40 to 200 μm, most typically from 50 to 170 μm, especially from 75 to 160 μm.

The organic polymer core may be in an amount of >50% based on the total weight of the interleavant particles, such as >55%, >70% or >75%.

The organic polymer core may be in an amount of <99.9% based on the total weight of the interleavant particles, such as <99.8%, <99.5% or <99%.

The organic polymer core may be in amount from 50 to 99.9% based on the total weight of the interleavant particles, typically from 60 to 99.8%, even more typically from 70 to 99.5%, even more typically from 75 to 99%. The organic polymer core may be in an amount of 75% based on the total weight of the interleavant particles.

Advantageously, the outer coating adheres successfully to the glass sheets.

The organic polymer core polymer content may be in an amount of >5% based on the total weight of the organic polymer core, such as >25% or >50% or >75, 85, 95 or approximately 100%.

The organic polymer core polymer content may be in an amount of <100% based on the total weight of the organic polymer core, such as <99% or <95%.

The organic polymer core polymer content may be in an amount of from 5 to 100% based on the total weight of the organic polymer core, such as from 20 to 100% or from 40 to 100% or from 90-100%.

The organic polymer core polymer may have a weight average molecular weight (Mw) >5,000 Da, typically >50,000 Da, typically >100,000 Da, typically >200,000 Da; which may include cross-linked polymers. Cross-linked polymers may have an unmeasurably high and/or infinite Mw.

The organic polymer core may have a softening point >65° C. as defined herein, typically, >70, 80, 90 or 100° C. There is no limit on the upper end of the softening point. However, this may be for example up to 300° C.

The organic polymer core may have a solubility in water of <1.5, 1.4, 1.2 or 1.0 g/L at 25° C.

The organic polymer core may have a compressive strength of at least 3.5, 4, 4.5, or 5 MPa at 25° C. There is no limit on the compressive strength but it will be typically, <150MPa such as <100, 50 or 10 MPa.

The organic polymer core may have a volumetric mass density <1.5, 1.4 or 1.3 g/cm3 at 25° C.

The organic polymer core may have a volumetric mass density >1.0, 1.1 or 1.2 g/cm3 at 25° C.

Typical ranges for the volumetric mass density are 1.05 to 1.6 g/cm³ at 25° C., more typically, 1.10 to 1.55 g/cm³, most typically, 1.15 to 1.45 g/cm³

The term cellulose herein includes cellulose derivatives. A suitable cellulose includes but is not limited to, microcrystalline cellulose, microfibrillated cellulose, cellulose ethers, cellulose esters, an enzymatically or chemically treated cellulose, an otherwise substituted cellulose. The term also encompasses cellulose containing compositions such as lignocellulose. The cellulose ether may be a material such as methyl cellulose, ethyl cellulose, hydroxy ethyl cellulose, hydroxypropyl cellulose, hydroxypropyl methyl cellulose, hydroxyethylmethyl cellulose or carboxy methyl cellulose. The hydroxy ethyl cellulose may be Natrosol™250 HEC. The cellulose ester may be cellulose acetate, propionate, butyrate, succinate, trimellitate or phthalate or mixed esters thereof with varying degrees of substitution. The microfibrillated cellulose may be Exilva@ F01-V or Exilva@ F01-L. Chemically treated cellulose includes rayon and cellophane. Such materials may be used for the organic polymer core.

### The Outer Coating

The term rosin herein includes gum rosin, wood rosin, tall oil rosin, oleorosin, abietic acids, neoabietic acids, sapinic acids, pimaric acids, isopimaric acids, palustric acids, and the like and any other products that are generally termed colophony.

The rosin may be a monovalent, divalent, or trivalent rosin salt of sodium, potassium, calcium, magnesium, zinc, manganese, aluminium, or any mixture thereof.

The rosin may be chemically modified. For example a rosin may be esterified, hydrogenated, dimerized, polymerized, disproportionated (such as by hydrogenation and dehydrogenation), functionalized, or any combination thereof.

For example, the rosin may be esterified through the reaction of rosin and alcohols, typically methyl, triethylene glycol, glycerol, and pentaerythritol. It will be understood that dimers, trimers, and oligomers of rosin may be produced through esterification will polyols.

For example, the rosin may be a partially or fully hydrogenated rosin (such as Staybelite-E™ or Foral AX-E™).

For example, the rosin may be dimerized or a dimeric rosin acid (such as Dymerex™ dimerised gum rosin).

For example, the rosin may be functionalised with reagents that react with at least one alkene bond, such as maleic anhydride or fumaric acid.

Multiple chemical modification may be made to the rosin. For example, the rosin may be dimerized then esterified. For example the rosin may be hydrogenated then esterified. For example the rosin may be esterified then functionalised.

Such materials may be used as film forming material for the outer coating.

The rosin as defined herein may form at least 50% w/w of the outer coating, more typically, at least 75% of the outer coating, most typically, at least 80% of the outer coating such as 85, 90, 95, 99 or 100% w/w of the outer coating.

The rosin may be in an amount of >0.025% based on the total weight of the interleavant particles, such as >0.05% or >0.125%.

The rosin may be in an amount of <40% based on the total weight of the interleavant particles, such as <20% or <10%.

The rosin may be in an amount from 0.025 to 40% based on the total weight of the interleavant particles, typically from 0.05 to 30%, even more typically from 0.125 to 25%.

The rosin may be in an amount of at least 1, 2 or 5% based on the total weight of the interleavant particles.

The outer coating may be in an amount of >0.1% based on the total weight of the interleavant particles, such as >0.2% or >0.5%.

The outer coating may be in an amount of <40% based on the total weight of the interleavant particles, such as <20% or <10%.

The outer coating may be in an amount from 0.1 to 40% based on the total weight of the interleavant particles, typically from 0.2 to 30%, even more typically from 0.5 to 25%. The outer coating may be in an amount of at least 4, 8 or 20% based on the total weight of the interleavant particles.

The outer coating may have an uncompressed thickness of <30 μm. Typically, the coating may have an uncompressed thickness of >0.1 μm. Such a coating may have an uncompressed thickness of from 0.2 to 28 μm, typically an uncompressed thickness of from 0.5 to 20 μm.

The outer coating may have an uncompressed thickness of from 0.1 to 50 μm, more typically 0.2 to 30 μm, most typically 0.5 to 20 μm. >65% of the organic polymer cores may be coated with the outer coating having such uncompressed thickness. ≥75% of the organic polymer cores may be coated with the outer coating having such uncompressed thickness. ≥85% of the organic polymer cores may be coated with the outer coating having such uncompressed thickness. ≥95% of the organic polymer cores may be coated with the outer coating having such uncompressed thickness and, in each case, this may be any one of the uncompressed thickness limits or ranges above.

The uncompressed thickness may be determined by a subtraction method whereby the mean particle size of the core particle is subtracted from the mean particle size of the coated particle. Particle size in this context is determined by the light scattering techniques mentioned herein.

The Mohs hardness in the Mohs hardness scale of the outer coating may be from 1 to 7, such as from 1 to 6, for example from 1 to 5. Typically, the outer coating is of a Mohs hardness that does not scratch or abrade the surface of the glass sheets when in use.

In some embodiments of the interleavant particles of the invention or interleavant particle composition, the coating is a powder coating.

### Outer Coating Additives

The outer coating may further comprise one or more additives selected from: acid functional modifiers, film forming agents, diluents, particulate fillers, processing aids, lubricant, plasticizer, agents for increasing the melt strength, agents for increasing abrasion resistance, hydrophobizing agents, coupling agents and adhesion promotors. The one or more additives may be biodegradable and/or water soluble.

The additive may comprise graphite or talc.

An acid functional modifier advantageously prevents or mitigates staining of the glass sheets. An acid functional modifier may also modify viscosity of the outer coating.

Generally, the outer coating may comprise one or more additives in an amount of >1% based on the total weight of the outer coating, such as >5%, >10% or >15%.

The outer coating may comprise one or more additives in an amount of <40% based on the total weight of the outer coating, such as <35%, <30% or <20%.

The outer coating may comprise one or more additives in an amount of from 1 to 40% based on the total weight of the outer coating, such as from 5 to 35%, 10 to 30% or from 15 to 20%.

The balance of the outer coating in each of the above % by weight of additive is in each case made of the outer coating material.

Although an acid functional modifier may be added to the outer coat, it is more usually mixed with the interleavant particles, for example it may be dry blended with the particles.

According to another aspect of the present invention there is provided a composition comprising the interleavant particles as defined herein.

Advantageously, the rosin outer coating may act as an acid functional modifier without the need for additional additive acid functional modifier.

The outer coating may further comprise one or more additive polymers to further modify the properties of the outer coating.

The glass sheets of any of these aspects may be flat or curved glass.

Glass sheets referred to herein are known to the skilled person in the art of glass sheet production and transport where interleavants are required. However, for the avoidance of doubt, such sheets would typically cover an area of at least 0.5m², more typically such sheets are much larger without limit of size and determined only by transport and manufacturing limitations such as up to 30, 50 or 100 m².

### Composition Additives

The interleavant composition may further comprise one or more additives which are substantially independent of any additive in the outer coating of the interleavant particles.

Typically, the interleavant composition additive may be selected from: acid functional modifiers, adhesion promoters such as microcrystalline cellulose, and flow modifiers to improve flow of the particles.

Typically, the further additive may be added to the composition by any suitable technique such as by blending, typically, powder blending the additive with the particles,

When present, the acid functional modifiers may form up to 50% w/w interleavant composition, typically, up to 40% w/w, more typically, up to 30% w/w. When present the acid functional modifier may form at least 1% w/w of the interleavant composition, typically, at least 5% w/w of the interleavant composition, more typically, at least 10% w/w of the interleavant composition. Accordingly, when present, the acid functional modifiers may be present at 1 to 50% w/W interleavant composition, typically, 7.5 to 45% w/w, more typically, 12.5 to 35% w/w.

When present, the adhesion promoters may form up to 10% w/w interleavant composition, typically, up to 7.5% w/w, more typically, up to 5% w/w. When present, the adhesion promoter may form at least 0.1% w/w of the interleavant composition, typically, at least 1% w/w of the interleavant composition, more typically, at least 2% w/w of the interleavant composition. Accordingly, when present, the adhesion promoter may be present at 0.1 to 10% w/w interleavant composition, typically, 0.5 to 8% w/w, more typically, 1.5 to 5% w/w.

When present, the flow modifiers may form up to 2% w/w interleavant composition, typically, up to 1% w/w, more typically, up to 0.5% w/w. When present, the flow modifiers may form at least 0.05% w/w of the interleavant composition, typically, at least 0.1% w/w of the interleavant composition, more typically, at least 0.5% w/w of the interleavant composition. Accordingly, when present, the flow modifiers may be present at 0.05 to 2% w/w interleavant composition, typically, 0.1 to 1.5% w/w, more typically, 0.2 to 1% w/w.

### Methodology

The method of producing the interleavant particles may comprise the step of: combining the organic polymer core and outer coating material to effect coating of the outer coating material on the organic polymer core.

The outer coating may be applied to the core by any suitable method, for example melt processing or coagulation/precipitation.

The outer coating may be combined with the organic polymer core by melt processing of the organic polymer core particles and outer coating material in an extruder or other melt processing apparatus.

The combining of the organic polymer core and outer coating material may be effected by high shear mixing. Typically, the heat generated by the said high shear mixing is sufficient to melt the outer coating material and effect coating of the outer coating material onto the organic polymer core. Typically, the organic polymer core is a solid particulate material and may be added to the high shear mixer as such.

Typically, the outer coating material is a solid at room temperature and normal temperatures of use as a glass interleavant and may be added as such to the high shear mixer with the organic polymer core wherein the outer coating material but not the core melts during the combining step.

Accordingly, the outer coating may be combined with the organic polymer core by high shear mixing of the organic polymer core particles with the outer coating material such that the heat generated by friction is sufficient to melt the outer coating material and deposit it on the surface of the organic polymer core particles. For this purpose the outer coating material has a lower melting point than the organic polymer core so that the core does not appreciably melt during the mixing process and the outer coating material does melt and thus by further mixing coats the organic polymer core particles.

Alternatively, slurry casting techniques can be used whereby the outer coating material is dispersed or dissolved in a solvent, mixed with organic polymer core particles to form a slurry and then the solvent is removed by a drying process such as spray drying, oven drying, vacuum drying, filter drying, fluidised bed drying or pan drying to produce the combination of inorganic core particles and outer coating material. Alternatively, an aqueous dispersion of outer coating material may be mixed with the organic polymer core and the coating may be applied to the core by coagulation or precipitation techniques followed by a suitable drying process. Alternatively, water may be added to a blend of the organic polymer core particles and the outer coating material to dissolve or partially dissolve the outer coating and deposit it on the outer surface of the core. The material may then be dried as per one of the drying processes described above.

The core particles may be prepared by ultrasonic spray pyrolysis.

Alternatively, the core particles may be prepared by milling.

Typically, the interleavant particles or compositions may be stored and/or applied as a dry powder, and/or a dry powder blend. Accordingly, the particles or compositions of the present invention are typically in the form of a free flowing dry powder.

The interleavant particles or compositions may be applied to the glass sheets by any suitable technique. For example, the interleavant particles or compositions may be applied by spreading, typically, by randomly spreading, an amount of at least 25 mg/m² of glass sheet, typically at least 50 mg/m². In another example, the interleavant particles or compositions may be applied by an applicator which charges the interleavant particles as they are sprayed on to the glass sheets with sufficient electrostatic charge. Typically, the interleavant particles or composition are disposed onto the surface of the glass sheet by spreading, typically, by randomly spreading, an amount of about from 100 to 8000 mg/m² of glass sheet, typically about from 200 to 6000 mg/m².

It will be appreciated by the skilled person that interleavant particles or compositions are used to protect glass sheets during transit and storage. As such, interleavant particle compositions are generally applied to glass sheets prior to storage and or transit but removed prior to or during use of the glass sheets. Accordingly, the interleavant particle compositions are such as to be easily removable by a suitable removing technique typically washing off with a fluid such as air or water, more typically water.

The softening point of a polymer as defined herein is determined as follows: 10 g of the sample material is spread evenly over the surface of a borosilicate glass petri dish (diameter 100 mm; depth 20 mm) such as Pyrex™ 3160-102. The weight of both the petri dish and sample are recorded. The petri dish is transferred to an oven set at 60° C. for 2 hours. The sample is then removed from the oven and allowed to cool to room temperature. The petri dish is inverted and gently tapped by raising the dish to a height of 1 cm and allowing it to drop under its own weight such that any loose material is removed. The weight of the petri dish after removal of loose material is recorded and the quantity of adhered material calculated as % w/w of sample remaining on the petri dish. A sample is considered to have a softening point >60° C. if the amount of sample remaining adhered to the petri dish is <1% w/w.

### Definitions

As used herein, unless otherwise expressly specified, all numbers such as those expressing values, ranges, amounts or percentages may be read as if prefaced by the word “about”, even if the term does not expressly appear. The term “about” when used herein means +/−10% of the stated value. Also, any numerical range recited herein is intended to include all sub-ranges subsumed therein. Singular encompasses plural and vice versa. For example, although reference is made herein to “an” alcohol, “a” compound according to formula (I), “a” rheology modifier, and the like, one or more of each of these and any other components can be used. As used herein, the term “polymer” refers to oligomers and both homopolymers and copolymers, and the prefix “poly” refers to two or more. The term “organic polymer” means natural or synthetic polymers with carbon atoms in the backbone and excludes inorganic polymer networks such as glass and other silicates.

Including, for example and like terms means including for example but not limited to. Additionally, although the present invention has been described in terms of “comprising”, the processes, products, and compositions detailed herein may also be described as “consisting essentially of” or “consisting of”.

By glass herein is meant a silicate, preferably a borosilicate, an aluminosilicate, a soda-lime silicate or a soda-lime-borosilicate. Typically, the glass herein, particularly in relation to the glass sheets is not fused silica or quartz glass.

Light scattering herein is determined by a Coulter LS230 laser diffraction instrument.

High shear mixing herein is carried out through use of a 304 stainless steel CG-9535A Anpro twin-blade coffee grinder (350W, 0.6 L, 22000 RPM).

Blending of powders herein is carried out using a Stuart SRT90 laboratory roller-mixer (60 RPM).

By “free from” herein is meant <1% w/w, more typically, <0.1% w/w.

The term density means the volumetric mass density at 25° C. unless indicated otherwise.

Where ranges are provided in relation to a genus, each range may also apply additionally and independently to any one or more of the listed species of that genus. All of the features contained herein may be combined with any of the above aspects in any combination.

For a better understanding of the invention, and to show how embodiments of the same may be carried into effect, reference will now be made, by way of example, to the following experimental data.

### EXAMPLES

### Characterisation Techniques

The mean particle size of the powder samples is determined using a Coulter LS230 laser diffraction instrument. Samples from Examples 1-9 were assessed for adhesion to glass by application of powder (200 mg, applied using a powder spray bottle) to lightly coat the surface of a 300×300×4 mm section of float glass. The adhesion to glass was determined by elevating the glass sheet to a 90° angle and firmly tapping the glass panel on the bench top to enable any loosely adhering particles to be released. Non-adhering material was collected and the mass quantified. The % mass retention of powder on the glass surface (i.e. the glass adhesion) was quantified for each sample.

### Comparative Example 1

Cellulose (Viscopearl™; mean particle size 143.1 um) manufactured by Rengo Co. Ltd. was used as supplied. The particle size was measured by laser diffraction. Adhesion of particles to glass were measured as described herein. Results are shown in Table 1.

### Example 2

Cellulose (Viscopearl™; mean particle size 143.1 um; manufactured by Rengo Co. Ltd., 99 g) and powdered rosin (Dymerex™, 1 g) were combined and blended at room temperature in a twin blade high shear mixer (350 W, 0.6 L, 22000 RPM), as detailed in the methodology section, for 5 minutes for sufficient time that the rosin particles were broken down to form a homogeneous composite powder whereby heat generated by friction promotes the formation of a coating of rosin on the surface of the cellulose cores. A thin coating of the cellulose particles with Dymerex™ rosin is observed by microscopic inspection of the particles. This is observable as a translucent film that coats the outside of the cellulose particles. The particle size was measured by laser diffraction. Adhesion of particles to glass were measured as described herein. Results are shown in Table 1

### Example 3

Rosin coated cellulose particles (prepared by method described in Example 2, 95 g) were added to Cellulose (microcrystalline cellulose [MCC] powder, mean particle size 20 μm, purchased from Sigma Aldrich, 5 g) and the two powders blended together at room temperature in a 0.3 L container by manual agitation for 5 minutes before further blending using the laboratory roller/mixer (60 RPM) for 2 hours until a homogeneous mixture was obtained. The particle size of the resultant mixture was measured by laser diffraction. Adhesion of particles to glass were measured as described herein. Results are shown in Table 1.

### Comparative Example 4

PMMA spheres (Colacryl@TS2050; mean particle size 50-60 μm) available commercially from Mitsubishi Chemical UK Specialty Polymers and Resins Ltd. were used as supplied. Adhesion of particles to glass were measured as described herein. Results are shown in Table 2.

### Example 5

PMMA spheres (Colacryl®TS2050; mean particle size 50-60 μm; available commercially from Mitsubishi Chemical UK Specialty Polymers and Resins Ltd, 99 g) and powdered rosin (Dymerex™, 1 g) were combined and blended at room temperature in a twin blade high shear mixer (350 W, 0.6 L, 22000 RPM), as detailed in the methodology section, for 5 minutes for sufficient time that the rosin particles were broken down to form a homogeneous composite powder whereby heat generated by friction promotes the formation of a coating of rosin on the surface of the PMMA cores. A thin coating of the PMMA particles with Dymerex™ rosin is observed by microscopic inspection of the particles. This is observable as a translucent film that coats the outside of the PMMA spheres. Adhesion of particles to glass were measured as described herein. Results are shown in Table 2.

### Example 6

Rosin coated PMMA spheres (prepared by method described in Example 5, 95 g) were added to Cellulose (microcrystalline cellulose [MCC] powder, mean particle size 20 μm, purchased from Sigma Aldrich, 5 g) and the two powders blended together at room temperature in a 0.3 L container by manual agitation for 5 minutes before further blending using the laboratory roller/mixer (60 RPM) for 2 hours until a homogeneous mixture was obtained. Adhesion of particles to glass were measured as described herein. Results are shown in Table 2.

### Comparative Example 7

PMMA spheres (Lucite®47Gi; mean particle size 145 μm) available commercially from Mitsubishi Chemical UK Specialty Polymers and Resins Ltd. were used as supplied. Adhesion of particles to glass were measured as described herein. Results are shown in Table 2.

### Example 8

PMMA spheres (Lucite®47Gi; mean particle size 147 um; available commercially from Mitsubishi Chemical UK Specialty Polymers and Resins Ltd, 99 g) and powdered rosin (Dymerex™, 1 g) were combined and blended at room temperature in a twin blade high shear mixer (350 W, 0.6 L, 22000 RPM), as detailed in the methodology section, for 5 minutes for sufficient time that the rosin particles were broken down to form a homogeneous composite powder whereby heat generated by friction promotes the formation of a coating of rosin on the surface of the PMMA cores. A thin coating of the PMMA particles with Dymerex™ rosin is observed by microscopic inspection of the particles. This is observable as a translucent film that coats the outside of the PMMA spheres. Adhesion of particles to glass were measured as described herein. Results are shown in Table 2.

### Example 9

Rosin coated PMMA spheres (prepared by method described in Example 8, 95 g) were added to Cellulose (microcrystalline cellulose [MCC] powder, mean particle size 20 μm, purchased from Sigma Aldrich, 5 g) and the two powders blended together at room temperature in a 0.3 L container by manual agitation for 5 minutes before further blending using the laboratory roller/mixer (60 RPM) for 2 hours until a homogeneous mixture was obtained. Adhesion of particles to glass were measured as described herein. Results are shown in Table 2.

Samples from Examples 1-9 were assessed for adhesion of particles to glass by the method described herein. Table 1 indicates the enhanced glass adhesion performance associated with Examples 2 and 3 which contain a rosin coating on the core cellulose particles compared to Examples 1 for which no rosin coating is present. Table 2 indicates similar enhanced glass adhesion for rosin coated PMMA particles of size 50-60 μm (Examples 5 and 6) over uncoated PMMA particles (Example 4). Although Examples 4-6 all exhibit acceptable adhesion of particles to glass; the enhancement in performance associated with the rosin coating in Examples 5 and 6 is notable. Table 2 also indicates similar enhancement in performance for larger PMMA particles (Example 7, size 145 μm) whereby the adhesion of particles to glass is improved by coating of PMMA cores with rosin (Examples 8 and 9). A further improvement to adhesion is achieved through the presence of microcrystalline cellulose (MCC) additive.

TABLE 1
Interleavant particle compositions comprising cellulose

| | | | | Mean particle |
|---|---|---|---|---|
| Formulation | Core | Coating | Adhesion (%) | size (μm) |
| Ex. | Cellulose (100 μm) | None | 12.029 | 143.1 |
| 1 (comparative) | | | | |
| Ex. 2 | Cellulose (100 μm) | Rosin (1 wt %) | 49.441 | 159.7 |
| Ex. 3 | Cellulose (100 μm) | Rosin (1 wt %) + | 50.86 | 156.5 |
| | | MCC (5 wt %) | | |

TABLE 2
Interleavant particle compositions comprising PMMA

| Formulation | Core | Coating | Adhesion (%) |
|---|---|---|---|
| Ex. 4(comparative) | PMMA (50 μm) | None | 76.64608 |
| Ex. 5 | PMMA (50 μm) | Rosin (1 wt %) | 87.37477 |
| Ex. 6 | PMMA (50 μm) | Rosin (1 wt %) + MCC | 83.39795 |
| | | (5 wt %) | |
| Ex. 7(comparative) | PMMA (140 μm) | None | 33.58928 |
| Ex. 8 | PMMA (140 μm) | Rosin (1 wt %) | 52.93211 |
| Ex. 9 | PMMA (140 μm) | Rosin (1 wt %) + MCC | 65.48353 |
| | | (5 wt %) | |

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. Interleavant particles for location between adjacent stacked glass sheets, the interleavant particles comprising an organic polymer core with an outer coating, wherein the organic polymer core has a softening point greater than 60° C., a solubility in water of less than 2 g/L at 25° C., a compressive strength of at least 3 MPa at 25° C. and a volumetric mass density less than 1.6 g/cm³ at 25° C., characterised in that the outer coating comprises rosin.

2. The interleavant particles according to claim 1, wherein the organic polymer core comprises a polymer selected from one or more of:
a polyester
a poly(ester-amide),
a polyurethane,
a poly(saccharide) or poly(saccharide) derivative,
a poly(methacrylate), poly(acrylate), poly(methyl methacrylate),
a poly(alkylene),
a polystyrene,
natural biopolymers and derivatives

3. The interleavant particles according to claim 1, wherein the polymer is selected from a poly(alkacrylate), poly(acrylate), poly(alkyl alkacrylate); a poly(alkylene); polystyrene, or a cellulose.

4. (canceled)

5. The interleavant particles of claim 3, wherein the cellulose is selected from a microcrystalline cellulose, microfibrillated cellulose, cellulose ether, cellulose ester, an enzymatically or chemically treated cellulose, an otherwise substituted cellulose and lignocellulose.

6. (canceled)

7. (canceled)

8. (canceled)

9. The interleavant particles according to claim 1, wherein the rosin is selected from gum rosin, wood rosin, tall oil rosin, oleorosin, abietic acids, neoabietic acids, sapinic acids, pimaric acids, isoprimaric acids, and/or palustric acids.

10. The interleavant particles according to claim 1, wherein the rosin is selected from a monovalent, divalent, or trivalent rosin salt of sodium, potassium, calcium, magnesium, zinc, manganese, aluminium, or any mixture thereof.

11. The interleavant particles according to claim 1, wherein the rosin is a chemical modified rosin selected from oligomerized, polymerized, disproportionated, esterified, hydrogenated, and functionalized rosins, or any combination thereof.

12. (canceled)

13. (canceled)

14. The interleavant particles according to claim 1, wherein the rosin forms at least 50% w/w of the outer coating.

15. (canceled)

16. The interleavant particles according to claim 1, wherein the outer coating comprises at least one additive in addition to rosin and wherein the additive is selected from one or more of an acid functional modifier, film forming agents, diluents, particulate fillers, processing aids, lubricant, plasticizer, agents for increasing the melt strength, agents for increasing abrasion resistance, hydrophobizing agents, coupling agent, and adhesion promotors.

17. (canceled)

18. The interleavant particles according to claim 1, wherein the interleavant particles have a mean particle size as determined by light scattering of ≤400 μm.

19. The interleavant particles according to claim 1, where the interleavant particles have a mean particle size as determined by light scattering of from 25 to 300 μm.

20. (canceled)

21. (canceled)

22. (canceled)

23. (canceled)

24. The interleavant particles according to claim 1, wherein the polymer of the core has a weight average molecular weight (Mw) >5,000 Da.

25. The interleavant particles according to claim 1, wherein the organic polymer core is from 50 to 99.9% w/w interleavant particles.

26. The interleavant particles according to claim 1, wherein the amount of the outer coating is from 0.1 to 40% w/w interleavant particles.

27. The interleavant particles according to claim 1, wherein the organic polymer core is a biodegradable material.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. A stack of glass sheets, wherein the glass sheets are spaced apart by interleavant particles or a composition according to any one of claim 1.

47. (canceled)

48. (canceled)

49. (canceled)

50. (canceled)

51. (canceled)

52. (canceled)

53. (canceled)

54. (canceled)

55. (canceled)

56. A method for producing an interleavant particle comprising the steps of combining a solid organic polymer core and a solid outer coating material by high shear mixing wherein the outer coating material has a lower melting point than the core material and the high shear mixing is effective to melt the outer coating material and to thereby effect coating thereof onto the solid organic polymer core.

57. The method according to claim 56, wherein the organic polymer core has a softening point greater than 60° C., a solubility in water of less than 2 g/L at 25° C., a compressive strength of at least 3 MPa at 25° C. and a volumetric mass density less than 1.6 g/cm³ at 25° C.

58. The method according to claim 56, wherein the outer coating comprises rosin.

59. The method according to any of claim 56, wherein the interleavant particle is according to claim 1.
